(19) United States
(12) Patent Application Publication
(10) Pub. No.: US 2012/0065947 A1
(43) Pub. Date: Mar. 15, 2012

(54) Collision Effect And Particle Information Update In Particulate Fluid Flow Simulations

(76) Inventor: Jiun-Der Yu, Sunnyvale, CA (US)

(21) Appl. No.: 12/878,784

(22) Filed: Sep. 9, 2010

(51) Int. Cl. G06F 17/10; G06F 7/60

(52) U.S. Cl. 703/2; 703/9

(57) ABSTRACT

To update particle information in a particulate fluid flow simulation, the new positions of the particles are determined by the balance of all forces, and such forces are calculated by taking surface integrals along the particle-fluid interface to reduce CPU overhead. A 3-D collision scheme for ellipsoidal particles to determine whether two or more ellipsoidal particles in the fluid flow collide, and if so, determine the location of the collision point between two colliding particles is also disclosed. Other aspects involve predicting the new location and orientation of each of the colliding particles after collision.

### CROSS-REFERENCE TO RELATED APPLICATION(S)

The present application is related to U.S. patent application Ser. No. 12/707,956, filed on Feb. 18, 2010, entitled “A Finite Difference Particulate Fluid Flow Algorithm Based on Level Set Projection Framework” (Attorney Docket No. AP426HO), which is incorporated by reference herein in its entirety.

### BACKGROUND

1. Field of Invention

The present invention is directed toward systems and methods for updating particle information in a particulate fluid flow, for digitally representing and storing such information, and for constructing and implementing a collision scheme to predict the behavior of colliding particles.

2. Description of Related Art

Particulate fluid flows are of great interest and of fundamental importance. Liquid toner, electrophoresis, and colloidal flows are just a few examples of particulate fluid flows. An easy model for particulate fluid flow consists of rigid solid particles and Newtonian fluid. To simulate particulate fluid flows with rigid solid particles, it is preferable to have an algorithm that solves the nonlinear Navier-Stokes equations and the particle effect at the same time.

Prior art methods for simulating particulate fluid flows include using the Navier-Stokes equations, which treat the particles as fluid with an additional constraint on the rigidity of the particles. An example of this method is illustrated in Nitin Sharma et al., A Fast Computation Technique for the Direct Numerical Simulation of Rigid Particulate Flows, Journal of Computational Physics, 205(2):439-457, May 20, 2005 (Sharma). Sharma's method is based upon a volume of fraction function approach to represent the particle-fluid boundary. A consequence of the Sharma method is that the numerical “thickness” of the interface is one cell.

The cross-referenced application identified above provides improvements on Sharma's technique as described in such application.

### SUMMARY OF INVENTION

The present disclosure provides still further improvements, particularly in updating various items of information regarding particles in a particulate fluid flow, and in designing and implementing a collision scheme to determine details regarding collision of particles.

As is the case in the related application, the incompressible Navier-Stokes equations are still solved and the rigid body motion enforced in a similar way. However, for updating the position and orientation of particles, an additional step of doing surface integrals is performed to obtain the forces and torques from the fluid. The force and torque on each particle, together with the effects of other body forces such as electrostatic force and gravitational force, is then used to update the linear and angular velocities, position, and orientation of each particle, instead of directly obtaining the new particles velocities and positions in the process of enforcing the rigid body motion. The cost (in terms of CPU time) of taking the surface integrals is small compared to the cost of enforcing the rigid body motion (when volume integrals need to be calculated), especially in three-dimensional simulations.

Taking the process still further, the present disclosure explains how to digitally represent and store particle information (such as location, orientation, shape and size, linear velocities, angular velocities, and moments of inertia) of ellipsoidal particles. From that, description is provided regarding the construction and implementation of a collision scheme that provides a criterion for deciding whether two particles are colliding, an algorithm to locate the point of collision, and an algorithm to determine the collision force, as well as the new linear velocity, angular velocity, location, and orientation of each of the colliding particles.

One aspect of the invention comprises a non-transitory medium encoded with instructions for execution by one or more processors to determine particle information in a particulate fluid flow in a simulation space. The instructions comprise instructions for setting a rigidity constraint force on particles in the particulate flow to an initial value; instructions for evaluating a plurality of governing equations including momentum equations together with an incompressibility constraint; instructions for obtaining a velocity field in a particle domain by projecting a flow field of the particles onto a rigid body motion space; instructions for calculating a new value for the rigidity constraint force; instructions for calculating a force and torque on the particles from the fluid; and instructions for determining, based at least in part on the calculated force and torque on the particles, updated velocity components, position, and orientation of at least one of the particles.

Preferably, the initial value is zero. Also, the instructions for calculating a force and torque on the particles preferably includes instructions for calculating stress on the surfaces of the particles and evaluating surface integrals on the particles to obtain the force and torque.

Preferably, the instructions for determining updated velocity components, position, and orientation of at least one of the particles is also based on other body forces.

In some embodiments, the instructions further comprise instructions for adding collision forces and updating the linear and angular velocity components of each particle determined to have collided, if any collisions have occurred.

In another aspect, the invention entails a non-transitory medium encoded with instructions for execution by one or more processors to execute to determine collision information with respect to particles in a particulate fluid flow simulation carried out in a computational domain divided into a plurality of mesh cells. The instructions comprise instructions for determining a force of each collision among the particles; and instructions for carrying out calculations for determining velocity components, position, and orientation of at least one of the two colliding particles after or during collision, wherein, the calculations are performed taking the center of the mesh cell in which the collision occurs as the contact point.

Other objects and attainments together with a fuller understanding of the invention will become apparent and appreciated by referring to the following description and claims taken in conjunction with the accompanying drawings.

### BRIEF DESCRIPTION OF THE DRAWINGS

In the drawings wherein like reference symbols refer to like parts.

FIG. 1 is a graphical illustration of a shape of function δ(\tilde{r}) of equations (9) and (10) herein.

FIG. 2A is a flow chart showing steps of a method for updating particle information in a particulate fluid flow simulation according to embodiments of the invention, and FIG. 2B illustrates sub-steps of one of the steps of FIG. 2A.

FIG. 3 is a diagram showing a particle and meshes.

FIG. 4 is an illustration of a global coordinate system and a local coordinate system for an ellipsoid, and a series of translation and rotations that transform one system to the other.

FIG. 5 is a flow chart showing steps of determining whether two particles are colliding according to embodiments of the invention.

FIG. 6 shows an ellipsoid, where \vec{e}_{M} is a unit vector along the instantaneous axis of rotation.

FIG. 7 is a flow chart showing steps of calculating the resultant forces and torques on each particle, updating that particle's location and orientation, and updating that particle's linear and angular velocities, according to embodiments of the invention.

FIG. 8 is a geometric diagram illustrating the collision of two rigid particles, where the impact point is P.

FIGS. 9A-9P show simulated movement of two ellipsoid particles using the collision theory and algorithm according to embodiments of the invention.

FIG. 10 is an illustration of a system in which embodiments of the present invention may be practiced.

### DESCRIPTION OF THE PREFERRED EMBODIMENTS

### I. Updating Particle Information

1. Governing Equations

One set of equations to be used is the momentum equations, which equations are to be solved in the entire domain (fluid and solid particles). The momentum equations are given by equations (1) and (2), which, along with the other equations numerically-referenced below, are set forth in the Appendix of the specification. In equation (2), Θ_{P} is an indicator function, which equals: 1 for each mesh cell completely occupied by particles, 0 for fluid, and is the ratio of the volume occupied by particles to the volume of the mesh cell.

Another equation to be used is the continuity equation, which is given as equation (3).

Because the particles are rigid bodies, a rigidity constraint is required, which leads to the vanishing of the deformation rate tensor, as shown in equation (4), where \vec{U} is the velocity of the particles' center of mass, \vec{ω} is the angular velocity of the particles, and \vec{r} is a vector from the center of mass to any point in the particles. Sharma points out that the tensorial rigidity constraint can be reformulated into the form set forth in equations (5).

Therefore, in the context of embodiments of this invention, the coupled fluid-particle problem may be solved in several steps.
a) First, the rigidity constraint force fᵣ is set to zero, and the momentum equations together with the incompressibility constraint are solved by any standard fractional-step scheme over the entire domain, i.e., from \vec{u}ⁿ to û, where û is an intermediate velocity field that is incompressible.
b) Second, the velocity field in the particle domain is obtained by projecting the flow field onto a rigid body motion space. Considering equation (6), to solve \vec{u}ⁿ⁺¹ inside the particle's region, equations (7) should be solved to get fᵣ.
c) Then, integrate the force and torque on the particles as indicated in equations (8), where \vec{σ}ₙ is the traction vector on the particle's surface, where the normal vector is \vec{n}.
d) Using the above force and torque, together with other body forces such as gravitational force and electrostatic force, the particles' respective new linear velocities, angular velocities, positions, and orientations can be determined.

2. Numerical Algorithms

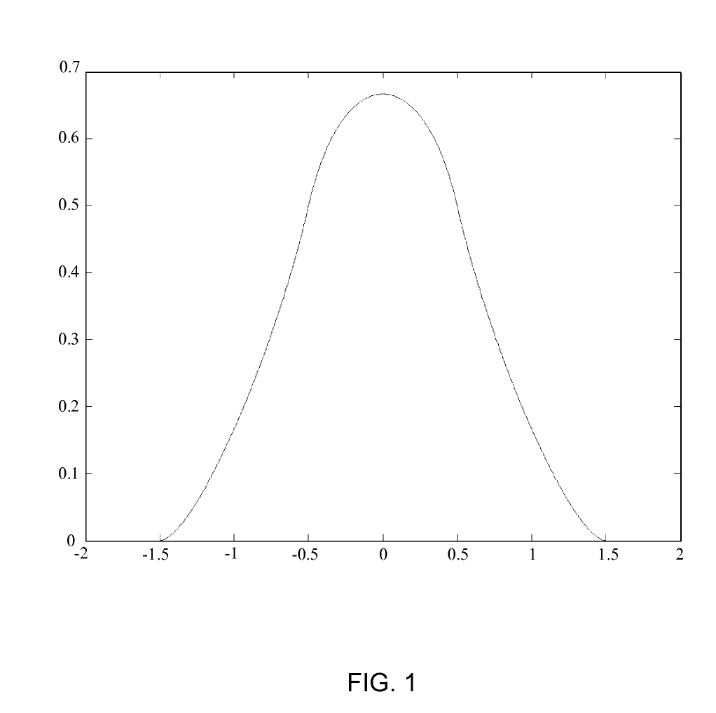

The subject numerical algorithms are described and illustrated in two-dimensions (2D), although from that disclosure it is straightforward to extend such algorithms to three-dimensions (3D). Any property defined at the material volumes within the particle can be constructed from such volumes using an interpolation operation, as set forth in equation (9). Here, it is assumed that the particle has an elliptic shape. Let (x₄, y₄) be a coordinate system in which three coordinate axes respectively align with the three main axes of an ellipsoid. Then, the relationships in equations (10) are obtained. Because the particle has an elliptic shape, determination of \tilde{r} is different than in the case where the particle has a circular shape. The function δ(\tilde{r}) exhibits the shape shown in FIG. 1.

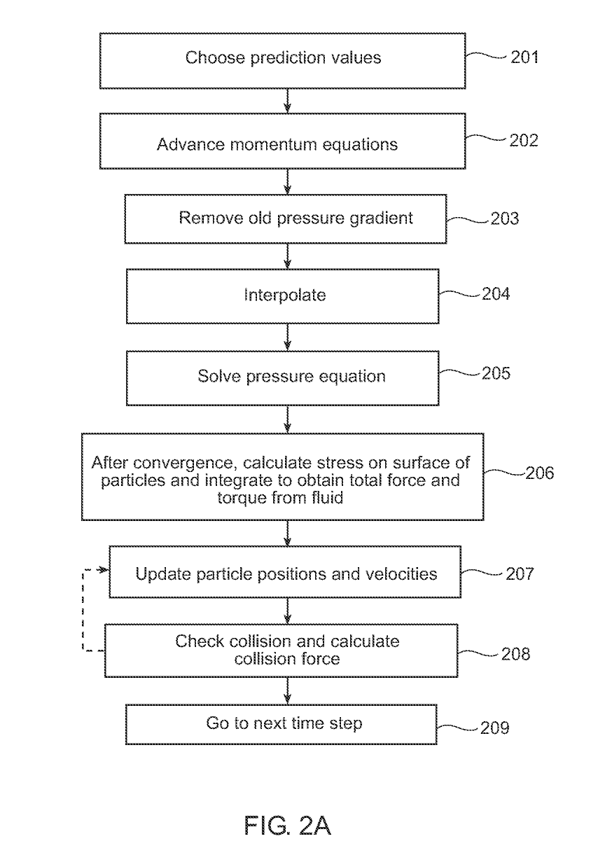

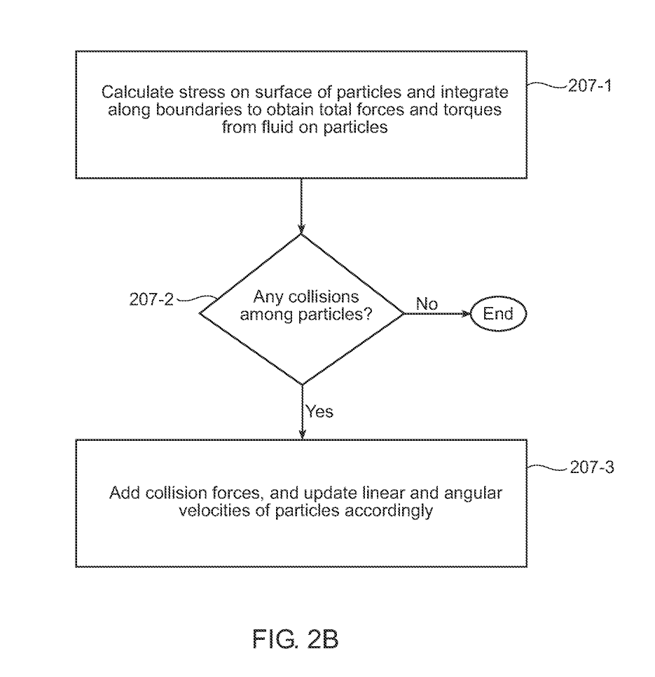

Next, the details of updating a particle's position and orientation with reference to FIG. 2A are described. The governing equations are solved using finite volume method (FVM), and all variables are defined at the mesh centers. The numerical algorithm involves the prediction-correction method, as explained below.

In step 201, the Adams-Bashforth extrapolation is used to choose the prediction values as set forth in equations (11), where \vec{u} is the velocity field, \vec{U} is the linear velocity of the particle, \vec{Ω} is the angular velocity of the particle. The superscript n represents the time step number, and the superscript “0” represents the initial value for iteration in a given time step. The subscript CV signifies the control volume in FVM, and P indicates the particles.

In step 202, the momentum equations are advanced using the fractional step method. For example, from k to k+1, yields equation (12), where N_{j,face} is a component of the outward face-normal, gᵢ=ρuᵢ, A is the area,

$${\hat{g}}_{i , face}^{k + 1 / 2} = \frac{1}{2} ( {\hat{g}}_{i , face}^{k} + {\hat{g}}_{i , face}^{k + 1} ) , {u}_{N}^{k + 1} = \frac{1}{2} ( {u}_{N}^{n} + {u}_{N}^{u + 1 , k} ) , \\ {\hat{τ}}_{ij , face}^{k + 1 / 2} = {{μ}_{F} [ \frac{1}{2} ( \frac{\partial {u}_{i}^{n}}{\partial {x}_{j}} + \frac{\partial {\hat{u}}_{i}^{k + 1}}{\partial {x}_{j}} ) + \frac{1}{2} ( \frac{\partial {u}_{j}^{n}}{\partial {x}_{i}} + \frac{\partial {\hat{u}}_{j}^{k + 1}}{\partial {x}_{i}} ) ]}_{face} ,$$

and f_{i,CV}^{n+1,k} includes both the internal force \vec{f}_{R} determined by equation (7) and external force \vec{f}ₑ.

In step 203, remove the old pressure gradient according to equation (13).

Step 204 involves interpolation according to equation (14).

In step 205, the pressure equation given by equation (15) is solved.

After convergence of the above, in step 206, calculate the stress on the surface of particles and integrate them to obtain the total force and torque from the fluid. (See step 202 above.)

Then, in step 207, update the particle position and velocities, and in step 208, check collision and calculate collision force. These two steps will usually require several iterations to obtain acceptable results, with more iterations yielding more accurate results.

After exiting the loop of steps 207 and 208, the algorithm goes to the next time step (step 209), in which case flow returns to step 201. After the last time step, the algorithm ends.

In step 207, update particle positions and compute velocities. Here, elliptic particles are taken as an example, with a circular particle deemed to be a special case of the elliptic particle. To update the particle position and velocity, the process entails two sub-steps, as illustrated in FIG. 2B. First, in step 207-1, calculate the stress on the surface of the particles and integrate along the boundary of the particles to obtain the total forces and torques (from the fluid) on the particles. Then, add body forces such as gravitational force, electrostatic force, etc. The linear acceleration and angular acceleration of each particle can be obtained, and the linear velocity and angular velocity of each particle updated after dt. In step 207-2, determine whether there are any collisions among particles. If so, in step 207-3, add the collision forces and update the linear velocities and angular velocities of the particles accordingly. For elliptic particles, the collision algorithm disclosed below may be used to calculate the collision force and its influence on related particles.

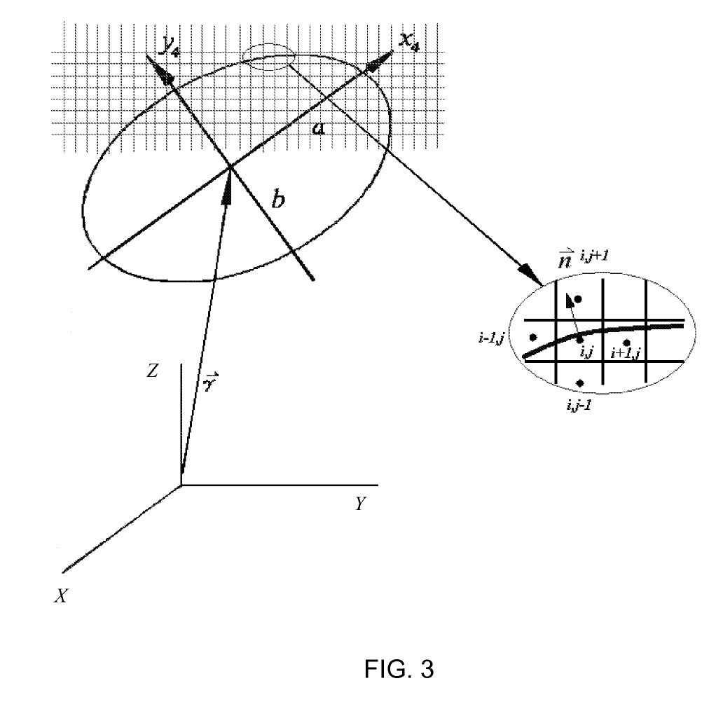

An algorithm for use in step 207-1 is described below. To determine the new position of particles, the stress tensor at the particle surface is calculated. FIG. 3 shows the particle and meshes. To calculate the stress at the surface of an elliptic particle, the mesh cells partially occupied by the particle are located first. In FIG. 3, the mesh (i,j) is one of these partially occupied cells. Using a differencing method, first get

$$\frac{\partial u}{\partial x} , \frac{\partial u}{\partial y} , \frac{\partial v}{\partial x} , \frac{\partial v}{\partial y} ,$$

then get the strain-rate tensor ε̅, and finally obtain the stress tensor σ̅=−p I̅+μ_{F} ε̅. The traction vector on this surface is given by \vec{σ}ₙ= σ̅·\vec{n}. According to the elliptic equation given in equation (16), where (x_{4,ij}, y_{4,ij}) are the coordinates of the center mesh cell (i,j), the components of \vec{n} in the local coordinate system (x₄, y₄) are given. It can also be approximated as set forth in equations (17), where: \tilde{x}_{4,ij}, \tilde{y}_{4,ij} replaces x_{4,ij}, y_{4,ij}. These two components of the unit normal vector are in the local (x₄, y₄) coordinate system. They will then be transferred back to the global (x, y) coordinate system. Also, the surface in the mesh (i,j) can be approximately determined by using the two intersection points of the ellipse with the mesh. Then, using equation (8), the total force and torque, \vec{F} and \vec{M} respectively, that the fluid exerts on the particle can be obtained from the integration. Finally, the linear velocity and angular velocity after dt can be obtained by equations (18). Other forces or torques, such as electrostatic and gravitational forces, can be included without difficulty. After that, the collision force, if any, should be considered according to the methodology explained in the next section.

Thus, according to embodiments of the invention, the new positions of the particles need not and are not determined directly by the solved velocity field. Instead, such positions are determined by the balance of all forces, which preferably include inertial force, pressure, viscosity force, body forces and collision force. Moreover, by calculating the forces on the particles by taking surface integrals along the particle-fluid surface, the cost in terms of CPU time is lower.

### II. 3D Collision Scheme

1. Collision Detection for a Pair of Ellipsoidal Particles

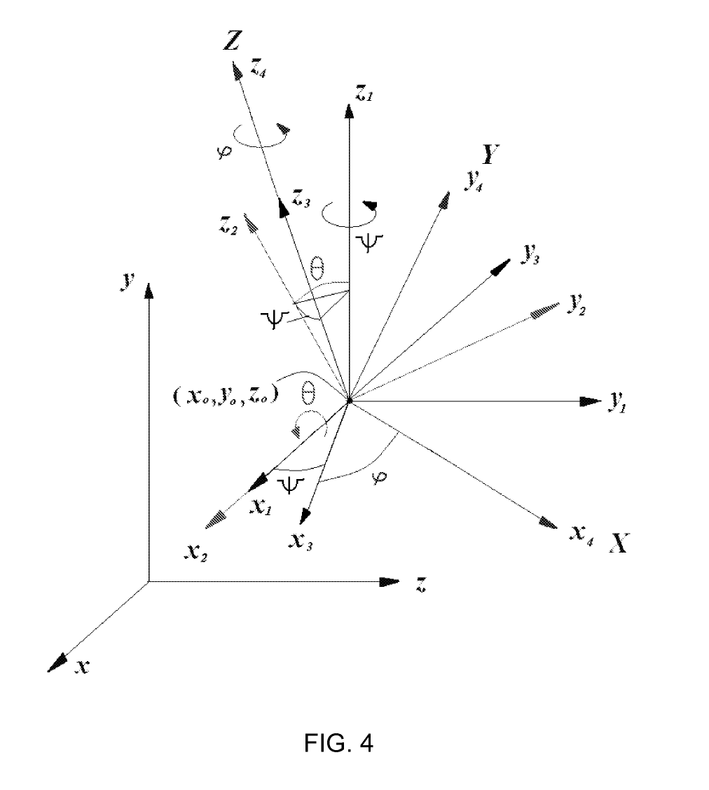

Suppose the configuration of a pair of ellipsoidal particles is defined by the locations of their centers of mass and the angles of their orientations. To be able to determine whether the ellipsoidal particles are colliding against each other, one needs to first determine the equations of the ellipsoidal particles in both a global and a local coordinate system. FIG. 4 displays the rotations that transform the global system to the local system. In FIG. 4, the coordinate system (x, y, z) is a global coordinate system fixed on earth, and (x₄, y₄, z₄) is a local coordinate system fixed on the ellipsoid. The three coordinate axes of the local system (x₄, y₄, z₄) are in the respective directions of the three major axes of an ellipsoid. The other coordinate systems (x₁, y₁, z₁), (x₂, y₂, z₂) and (x₃, y₃, z₃) are intermediate coordinates that help us do the coordinate transform from the global system fix on earth to the local system fixed on the ellipsoid. The steps for carrying out the transform from (x, y, z) to (x₄, y₄, z₄) are as follows.

Translate the coordinate system (x, y, z) to (x₁, y₁, z₁). For the translational coordinate transfer, equations (19) may be used.

Rotate the coordinate system (x₁, y₁, z₁) around the x₁ axis by an angle θ to the new coordinate system (x₂, y₂, z₂). For the rotational coordinate transfer, equations (20) may be used. It is noted that the axes of the intermediate coordinate system are orthonormal, as indicated in equations (21).

Rotate the coordinate system (x₂, y₂, z₂) around the z₁ axis by an angle ψ to the new coordinate system (x₃, y₃, z₃). For the rotational coordinate transfer, equations (22) may be used. Again, the axes of the intermediate coordinate system are orthonormal, as indicated in equations (23).

Rotate the coordinate system (x₃, y₃, z₃) around the z₃ axis by an angle φ to the new coordinate system (x₄, y₄, z₄). For this rotational coordinate transfer, equations (24)-(27) may be used.

Relate the local and global coordinate systems according to equations (28) and (29). Similarly, for the instantaneous angular velocity vector, there are the relationships set forth in equations (30).

Next, determine the form of the equations of an ellipsoidal particle in the local and global coordinate systems. It is clear that the lengths of the three major axes (a, b, c) will not change during the coordinate translation or rotation. In the local coordinate system (x₄, y₄, z₄), the equation of the ellipsoidal particle is given by equation (31). Considering equations (26) and (29), equations (32) are obtained.

One can solve (X, Y, Z) in terms of (x₁, y₁, z₁) by Cramer's rule. Because (x₁, y₁, z₁) and (x₄, y₄, z₄) are right handed coordinate systems, equation (33) is obtained. Given equations (34), then Cramer's rule yields equations (35).

By noting that x=x₁+x₀, y=y₁+y₀, z=z₁+z₀, gives equation (36), which is the equation of the ellipsoidal particle in the global system fixed on earth. The instantaneous angular velocity vector can be written in short as equation (37).

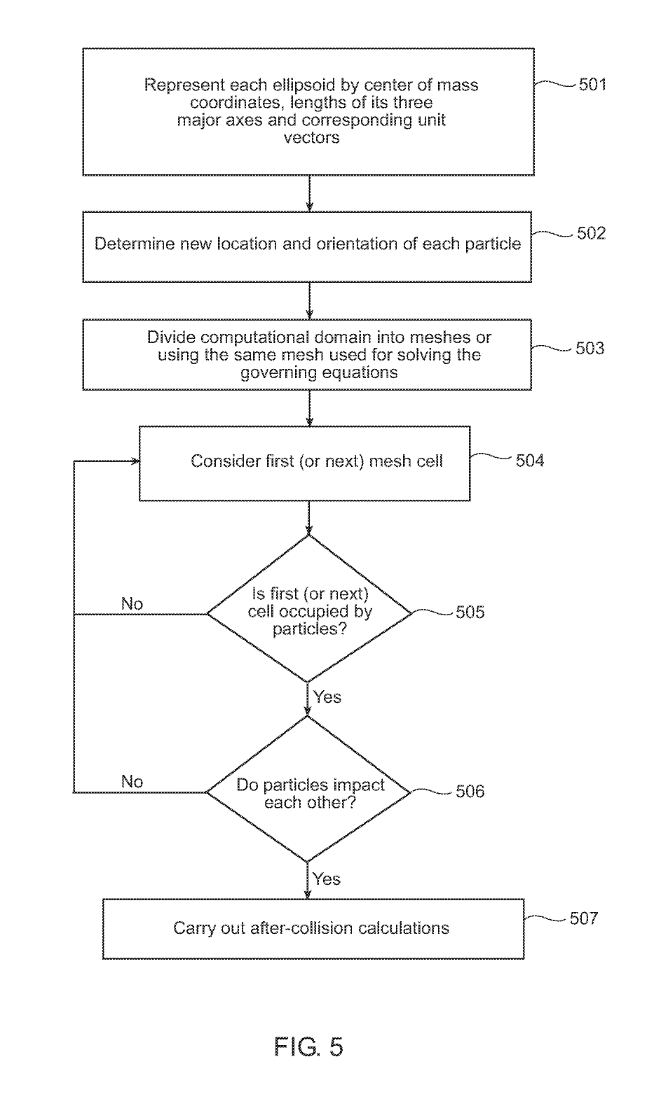

To consider the collision of particles requires the handling of at least two particles at the same time, which means that at least one ellipsoidal equation will be as complicated as equation (36) whichever local or global coordinate system is used. It is difficult, if not impossible, to directly check whether two particles are colliding with each other and to locate the point of collision. Therefore, the following approximate approach can be used. Such approach is described with reference to FIG. 5, and can be used to implement steps 207 and 208 of FIGS. 2A and 2B, although for collision detection itself other known and compatible method may also be used.

Initially, each ellipsoid is represented by the coordinates of its center of mass—the lengths of its three major axes and the three corresponding unit vectors (step 501). Supposing that an ellipsoid located at (x₀, y₀, z₀) has major axes along (\vec{e}ₓ₄, \vec{e}_{y4}, \vec{e}_{z4}) and major axis length (a, b, c), the velocity of its center of mass is (Vₓ, V_{y}, V_{z}) and the angular velocity vector is (ωₓ, ω_{y}, ω_{z}). According to the solution of Navier-Stokes equations and consideration of other external forces, the total \vec{F} and \vec{M} on it can be obtained.

Then, in step 502, which is essentially equivalent to step 207, determine the new location of this ellipsoid's center of mass according to equations (38), and determine its change of orientation angle according to equations (39), where I_{ω} is the moment of inertia. In this way, the new location and orientation of each particle can be determined. The Δt used may only be a fraction of that used for solving the Navier-Stokes equations.

The following steps in FIG. 5 are essentially focused on one possible implementation of step 208. Other compatible implementations may also be used.

Depending on the accuracy of the results desired, the computational domain can be further divided into more meshes (step 503). Alternatively, the same mesh that was used for solving the governing equations can be used, in which case step 503 can be skipped.

Next, consider each mesh cell in turn (step 504) to determine if it is totally or partially occupied by particles (step 505). This operation is preferably carried out as follows. Let the coordinates of the center of mass of a mesh cell be (x_{c,m}, y_{c,m}, z_{c,m}). Use equations (19) and (32) to get the relative coordinates (X_{c,m}, Y_{c,m}, Z_{c,m}) with respect to the local coordinate system centered at the mass center of the ellipsoid in consideration. Substitute them into equation (31). If

$$\frac{{X}_{c , m}^{2}}{{a}^{2}} + \frac{{Y}_{c , m}^{2}}{{b}^{2}} + \frac{{Z}_{c , m}^{2}}{{c}^{2}} - 1 < 0 ,$$

then the mesh cell is totally or partially occupied by the particle. In that case, proceed to determine which of the eight nodes of this mesh cell is located in the particle in the same way. Because all meshes in the computational domain are carefully generated so that they are small enough, for each of the eight nodes the algorithm gives a weight of 12.5%. This is to say that if it is decided that n (n≦8) corner nodes are in the particle, the algorithm considers that n*12.5% of the mesh cell is occupied by the particle.

If it is found that the present mesh cell is occupied by two particles, then these two particles may impact each other. Thus, whether the two particles impact each other is determined in step 506. If n₁+n₂>8, where n₁ and n₂ are respectively the number of corner nodes occupied by the first and second particles, or any node of this mesh cell is occupied by both particles, then these two particles must impact each other. It is also possible that the collision occurs in more than one mesh cell. In that case, consider the mesh that gives the maximum n₁+n₂ as the position of collision between these two particles. To avoid the possibility of collision in too many mesh cells, the mesh should be fine enough and the time step small enough. If the particles impact each other (i.e., there is a collision between the two particles), after-collision calculations are carried out (step 507), as described below.

Note that steps 504-506 are executed in a loop until all mesh cells have been considered.

2. Numerical Algorithm for Computation of Movement After Collision

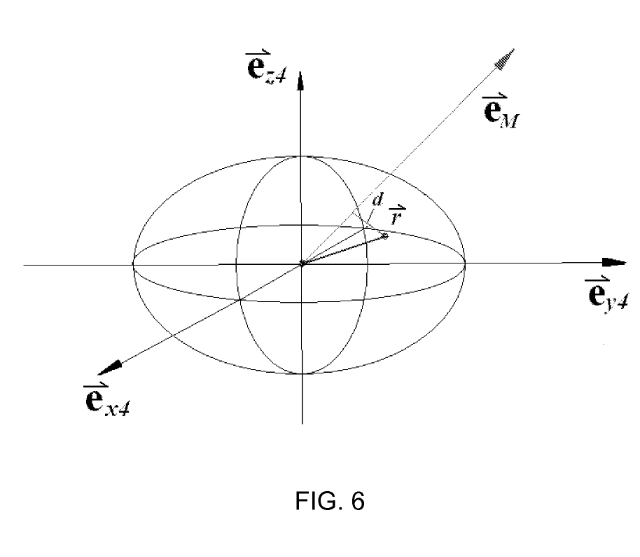

After determining the mesh cell in which the collision occurs, the center of the mesh is considered as the collision point. Before considering the collision effect on particles, first calculate the resultant forces and torques on each particle, update the particle location and orientation, and update the particle's linear and angular velocities. To do these things, first determine the moment of inertia with respect to the instantaneous rotation axis. FIG. 6 shows an ellipsoid, where \vec{e}_{M}, is a unit vector along the instantaneous axis of rotation.

According to the definition of moment of inertia, there is equation (40), where [symbol] \vec{e}ₓ₄, \vec{e}_{M} [symbol] , [symbol] \vec{e}_{y4}, \vec{e}_{M} [symbol] , [symbol] \vec{e}_{z4}, \vec{e}_{M} [symbol] denote the angles between the two vectors in the square bracket. Considering the relationships in equation (41), yields equation (42).

If I_{G} is defined as in equation (43), the relationships of equations (44) hold.

It is noted that I_{G}, Iₐ, I_{b}, I_{c} are values that do not change during simulation and, hence, can be calculated at the beginning of a simulation and stored in memory. For a sphere, there is equation (45).

Combining yields equation (46).

Since in the simulation the instantaneous axis of rotation may change, the moment of inertia I_{M}, will also change in the simulation.

By basic calculus, there is equation (47), where

$${V}_{E} = \frac{4}{3} π a b c .$$

In a similar way, equations (48) can be obtained.

Now consider how to update the particle location, orientation, and velocity. Let \vec{e}ₘ be a unit vector in the

$$( {\vec{ω}}_{0} + \frac{1}{2} \frac{\vec{M}}{{I}_{M}} Δ t ) Δ t$$

direction, i.e.,

$${\vec{e}}_{m} // ( {\vec{ω}}_{0} + \frac{1}{2} \frac{\vec{M}}{{I}_{M}} Δ t ) Δ t .$$

Construct two unit vectors \vec{e}ₘ₁ and \vec{e}ₘ₂ such that (\vec{e}ₘ, \vec{e}ₘ₁, \vec{e}ₘ₂) form a right handed orthonormal vector base as a coordinate system. The following shows the relationship between (\vec{e}ₘ, \vec{e}ₘ₁, \vec{e}ₘ₂) and (\vec{e}_{x4,0}, \vec{e}_{y4,0}, \vec{e}_{z4,0}). There is more than one way to construct (\vec{e}ₘ, \vec{e}ₘ₁, \vec{e}ₘ₂). If \sqrt{m_{y4}²+m_{z4}²} is not too small, select equations (49). If \sqrt{m_{y4}²+m_{z4}²} is too small, do the construction based on either \sqrt{mₓ₄²+m_{z4}²} or \sqrt{mₓ₄²+m_{y4}²} not too close to zero. In those cases, the formula will change accordingly. For example, assuming \sqrt{mₓ₄²+m_{y4}²} is not close to zero, equations (50) is obtained.

It is clear that \vec{e}ₘ, \vec{e}ₘ₁ and \vec{e}ₘ₂ are unit vectors and they construct a right-hand Cartesian system. Then, there is equations (51).

Because after rotation around \vec{e}ₘ with angle

$$α = \vert ( {\vec{ω}}_{0} + \frac{1}{2} \frac{\vec{M}}{{I}_{M}} Δ t ) Δ t \vert$$

(in the right-hand direction), \vec{e}ₘ does not change, yielding equations (52).

Because (\vec{e}ₘ, \vec{e}ₘ₁, \vec{e}ₘ₂) and (\vec{e}_{x4,0}\vec{e}_{y4,0}\vec{e}_{z4,0}) rotate together and with the same angle α, so the relationships between (\vec{e}ₘ, \vec{e}ₘ₁, \vec{e}ₘ₂) and (\vec{e}_{x4,0}\vec{e}_{y4,0}\vec{e}_{z4,0}), as well as those between (\vec{e}_{m,n}, \vec{e}_{m1,n}, \vec{e}_{m2,n}) and (\vec{e}_{x4,n}\vec{e}_{y4,n}\vec{e}_{z4,n}), are the same, equations (53) can be obtained.

Substituting (51) into (52), yields equations (54). This set of equations is used to calculate the new orientation (\vec{e}ₓ₄, \vec{e}_{y4}, \vec{e}_{z4}) after Δt.

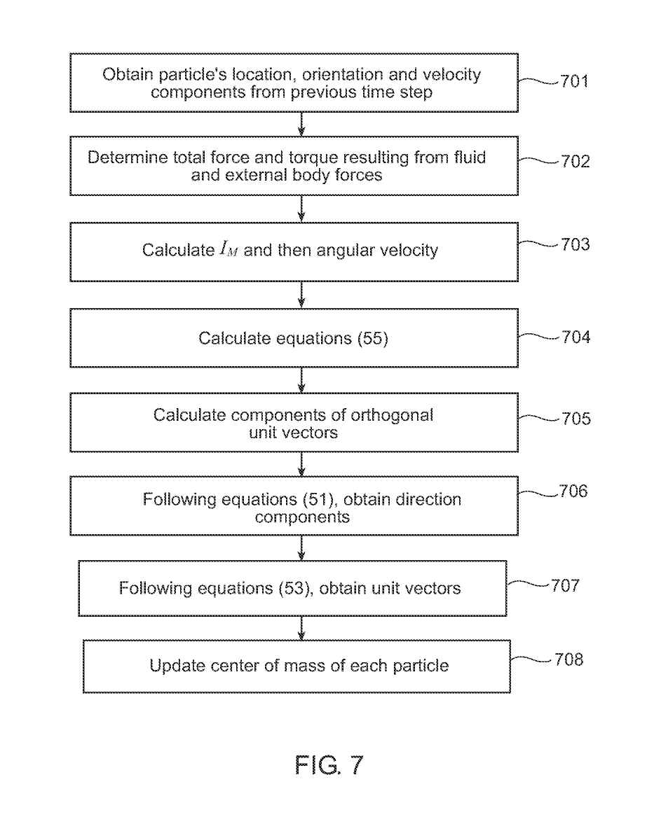

A flow chart summarizing the above process is shown in FIG. 7. Start with components ω₀, \vec{e}_{x4,0}, \vec{e}_{y4,0}, \vec{e}_{z4,0}, and \vec{e}_{c,0}, which are deemed as given in the current time step, having been obtained in the previous time step (step 701). In step 702 (or step 206), obtain the total force \vec{F} and torque \vec{M} that result from the fluid and external body forces by taking surface integrals in the global Cartesian coordinate system (x, y, z). In step 703, calculate I_{M} and then

$$( {\vec{ω}}_{0} + \frac{1}{2} \frac{\vec{M}}{{I}_{M}} Δ t ) Δ t$$

in the global (x, y, z) coordinate system. Note that \vec{e}ₘ is a unit vector in the direction of

$$( {\vec{ω}}_{0} + \frac{1}{2} \frac{\vec{M}}{{I}_{M}} Δ t ) Δ t ,$$

so its components (x, y, z) are known. Also, equation (55) is obtained. In step 704, calculate equations (56). Following equations (49), calculate the components of \vec{e}ₘ₁, \vec{e}ₘ₂ in the (x, y, z) coordinate system (step 705). Following equations (51), q_{x4,m}, q_{y4,m}, q_{z4,m}, q_{x4,m1}, q_{y4,m1}, q_{z4,m1}, q_{x4,m2}, q_{y4,m2}, q_{z4,m2} are obtained (step 706). Following equations (54), yields \vec{e}_{x4,n}, \vec{e}_{y4,n}, \vec{e}_{z4,n}, where n=1 (step 707). Then, in step 708, update the center of mass of each particle using equation (57).

By repeating steps 702 to 708 a few times, where Δt is actually a fraction of the time step used to solve the Navier-Stokes equations, the new configuration of the ellipsoid, including its center of mass, orientation of the three major axes, and linear and angular velocities can be accurately determined.

Next, consider the collision effect. According to the above relationship between (x₄, y₄, z₄) and (x_{4,n}, y_{4,n}, z_{4,n}), i.e., (\vec{e}_{x4,0}, \vec{e}_{y4,0}, \vec{e}_{z4,0}) and (\vec{e}_{x4,n}, \vec{e}_{y4,n}, \vec{e}_{z4,n}), the new location and orientation of the ellipsoids are known. The algorithm in section II.1 is then followed to check whether a collision occurs in any mesh cell. If a collision occurs, calculate the force due to the collision. Because the effects of collision forces will be added to the ellipsoids step 703 and 704 are repeated.

If the particles are rigid, the collision is purely elastic. In that case, the impact point is given by P, as indicated in FIG. 8. To determine the force and torque due to collision, calculate the velocity of the collision points on the two particles, respectively, which may be done according to equations (58) and (59). The outward unit normal vectors at the collision points are then calculated on the two ellipsoids in the local coordinate system, and then transferred to the global coordinate system. Equation set (60) shows the process mathematically.

In the above, the subscript p denotes the collision point, subscripts a, b denote particles A and B, respectively, \vec{e}ₓₐ, \vec{e}_{ya}, \vec{e}_{za} are the unit vectors along the three major axes of particle A, \vec{n}_{p,na,4} is a unit vector at collision point P, which vector is normal to the surface of particle A, where subscript “4” refers to the local coordinate system fixed on particle A. The vectors \vec{e}_{xb}, \vec{e}_{yb}, \vec{e}_{zb}, \vec{n}_{p,nb,4} are those corresponding quantities for particle B. Equations (60-3) and (60-4) indicate the transfer of the expression of the normal unit vectors in their local coordinate system fixed on particles into the global coordinate system fixed on earth. The vector \vec{n}_{p, n̅} is the mean direction of \vec{n}_{p,na} and −\vec{n}_{p,nb}, as shown in the small side diagram of FIG. 8.

Now construct a right handed system with base unit vectors: \vec{n}_{p, n̅}, \vec{τ}_{1, n̅}, \vec{τ}_{2, n̅}, which are orthogonal to one another. This may be done by: (i) finding two components of \vec{n}_{p, n̅}, say nₓ, n_{y}, so that \sqrt{nₓ²+n_{y}²}>0.3 (if this cannot be satisfied, select other components); (ii) let \vec{τ}_{1, n̅}=(−n_{y}\vec{e}ₓ+nₓ\vec{e}_{y})/\sqrt{nₓ²+n_{y}²}, which is unit and normal to \vec{n}_{p, n̅}, and (iii) let \vec{n}_{p, n̅}×\vec{τ}_{1, n̅}=\vec{τ}_{2, n̅}. With \vec{n}_{p, n̅}, \vec{τ}_{1, n̅}, \vec{τ}_{2, n̅} calculated, all the necessary geometric values and vectors are at hand to calculate various values after collision.

For collision theory, consider there is a relation between the speed that the surfaces of two particles approach and leave each other. This first notion of the present collision theory can be formulated as per equation set (61), in which e is the restitution coefficient. For a fully elastic collision, e is 1. Otherwise, it is a positive value between 0 and 1. The value of e can be determined according to the material property of particles. In addition, the subscript i indicates the status just before the collision, while the subscript f means the status after collision. Using equations (58) and (59), gives the series of derivation shown in equations (61-3). Equation (61-3) is the last format of equation (61) and is preferred among the other options for this theory. The second set of equations for this collision theory is for the collision force vector \vec{I}. They can be formulated as per equation set (62), where \vec{I} is the collision force vector drawn from particle A to particle B, Iₓ, I_{y}, I_{z} are the three components of \vec{I} in the global coordinate system, and I _{n̅}, I _{τ̅}_{₁}, I _{τ̅}_{₂} are the three components of \vec{I} in \vec{n}_{p, n̅}, \vec{τ}_{1, n̅}, \vec{τ}_{2, n̅}, where μ is the friction coefficient that is related to the material property of particles. Equations (62-4, 5) give the forms of equations (62-3) in the global coordinate system (x, y, z). It is noted that the friction force is in the opposite direction to the relative tangent velocity at the collision point. The final parts of our collision theory are from the conservation of linear and angular momenta. Equations (63) and (64) equate the linear momentum and angular momentum of two particles before and after collision (subscript i for before and subscript f for after). In equations (63) \vec{r}_{ca,p} is a vector from the center of mass of particle A to the collision point P, and in equations (64) \vec{r}_{cb,p} is a vector from the center of mass of particle B to collision point P.

Note there are 15 unknown variables (\vec{V}_{c,a,f}, \vec{ω}_{a,f}, \vec{I}, \vec{V}_{c,b,f}, \vec{ω}_{b,f}) and 15 equations (including six each in equation sets (63) and (64), one in equation (61-3), and two in equations (62-4)). So, the number of equations is the same as the number of variables.

It is noted that the direction of rotation of the ellipsoids changes during collision. That means that I_{M} will change because it depends on the instantaneous direction of rotation of the ellipsoid. Therefore, the equation is nonlinear. In a simulation, the prediction correction method is used: the initial value of I_{M} is used; after a solution is obtained, it is modified according to the average value of the initial and obtained values; and finally, the equation is solved again and the approximate result is obtained. In contrast, for spheres, I_{M} is constant. So, in that case, the equation system is linear and the results can be solved directly without performing the prediction correction steps.

3. Numerical Example

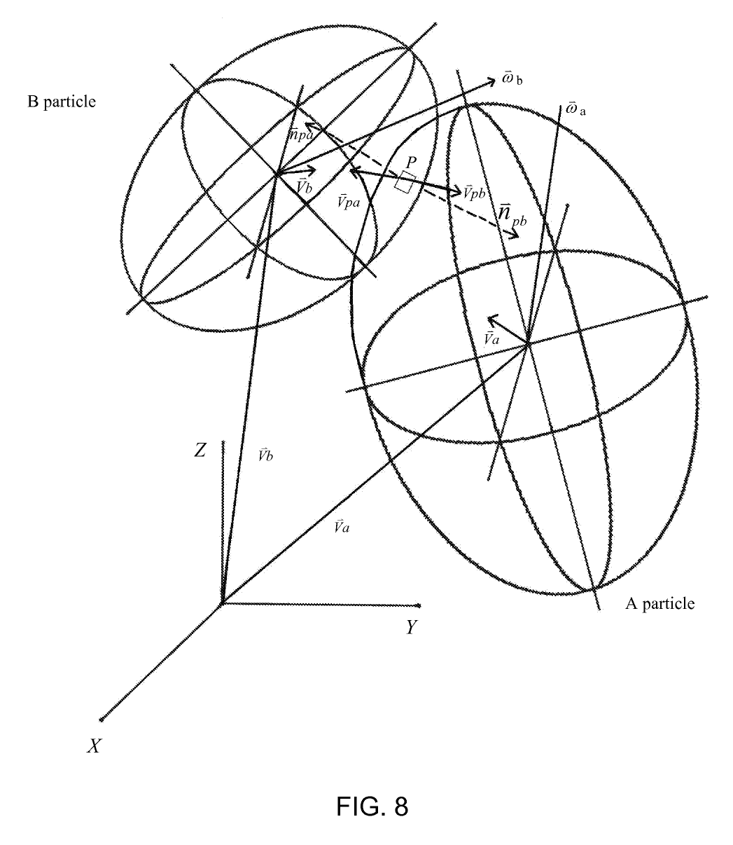

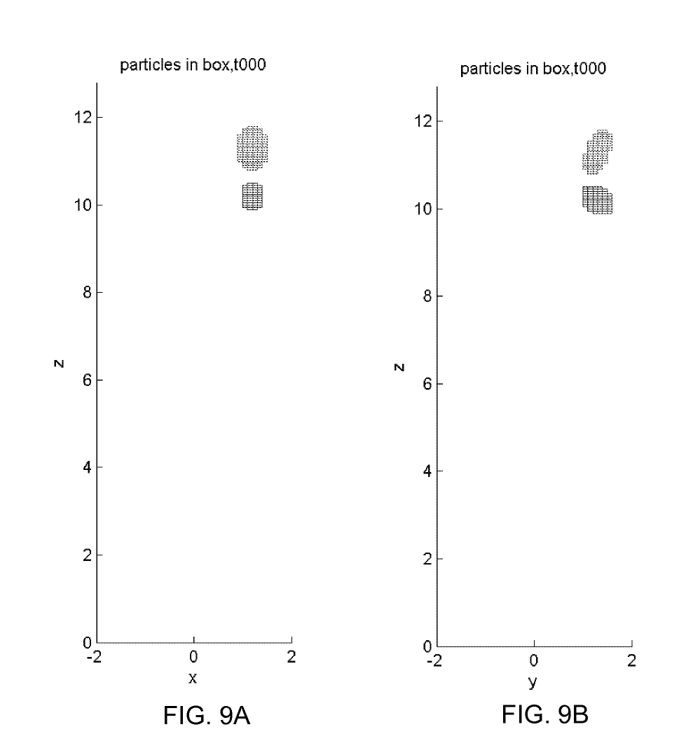

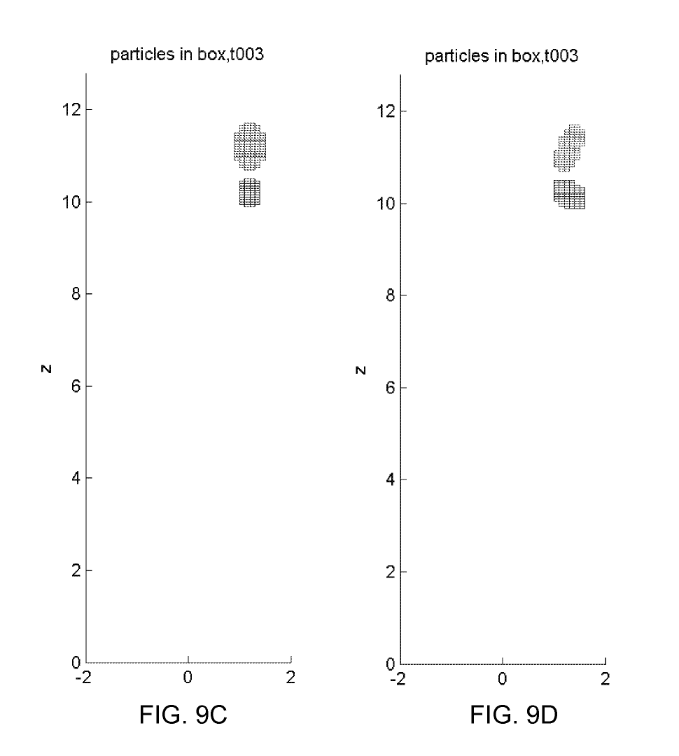

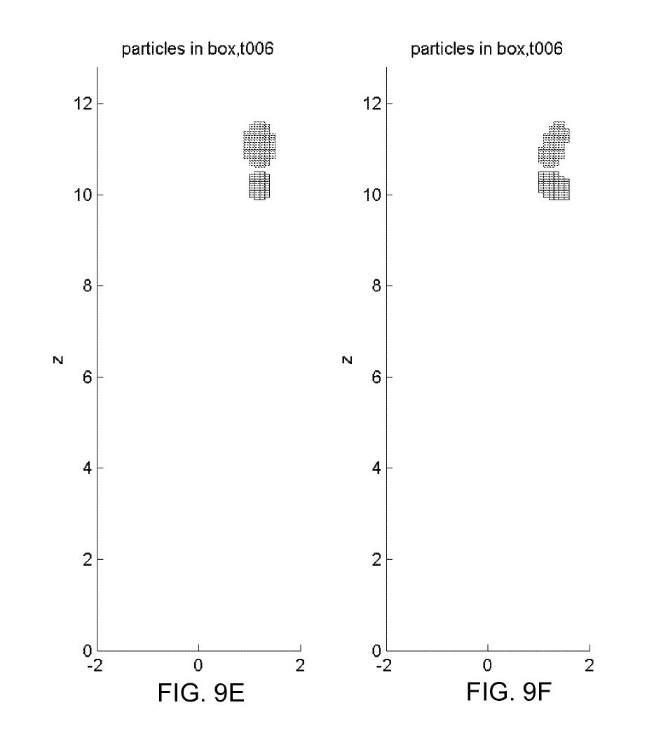

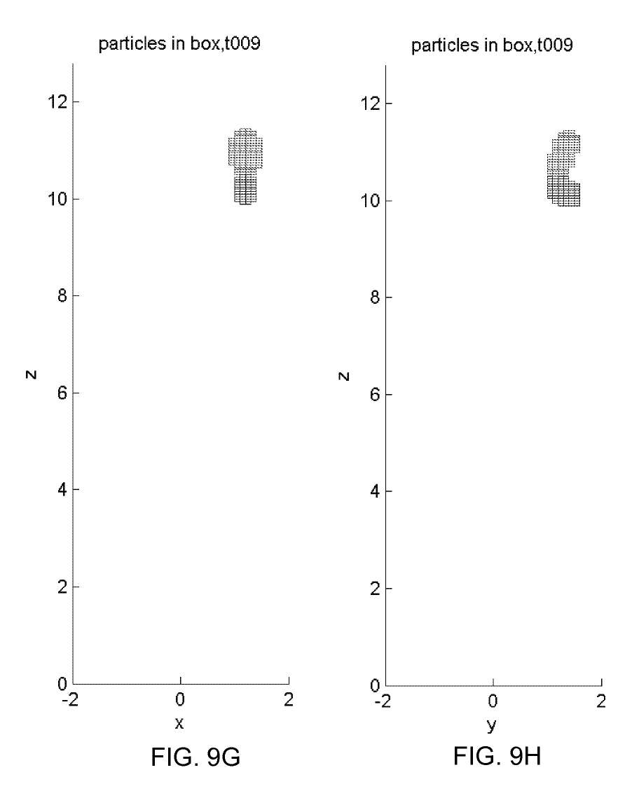

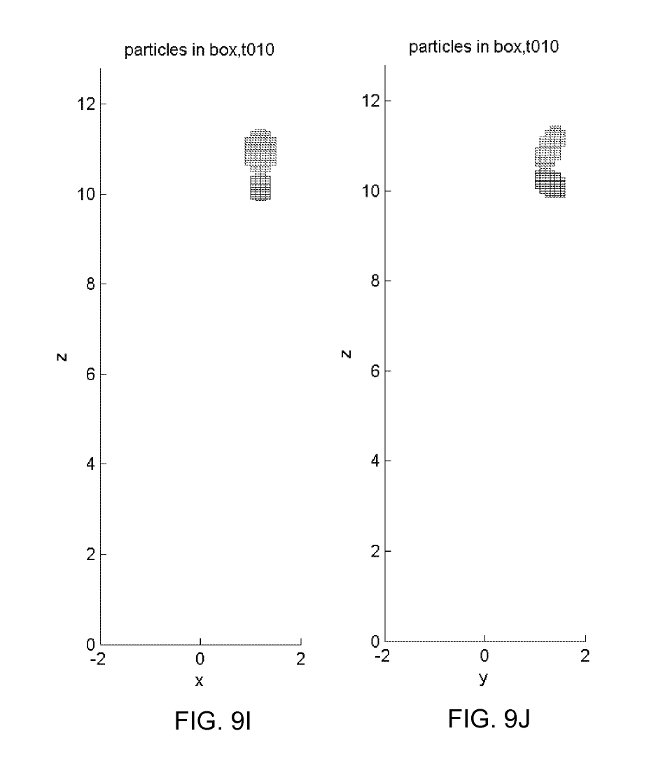

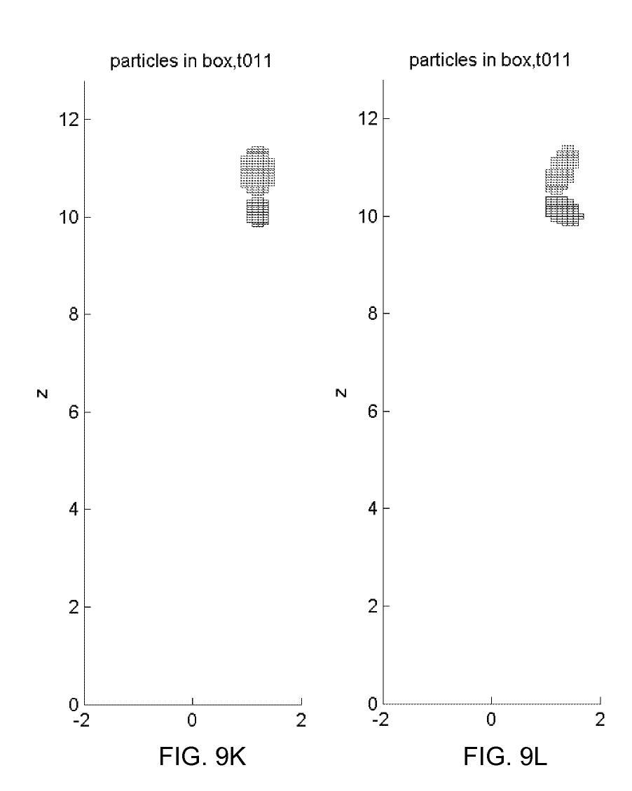

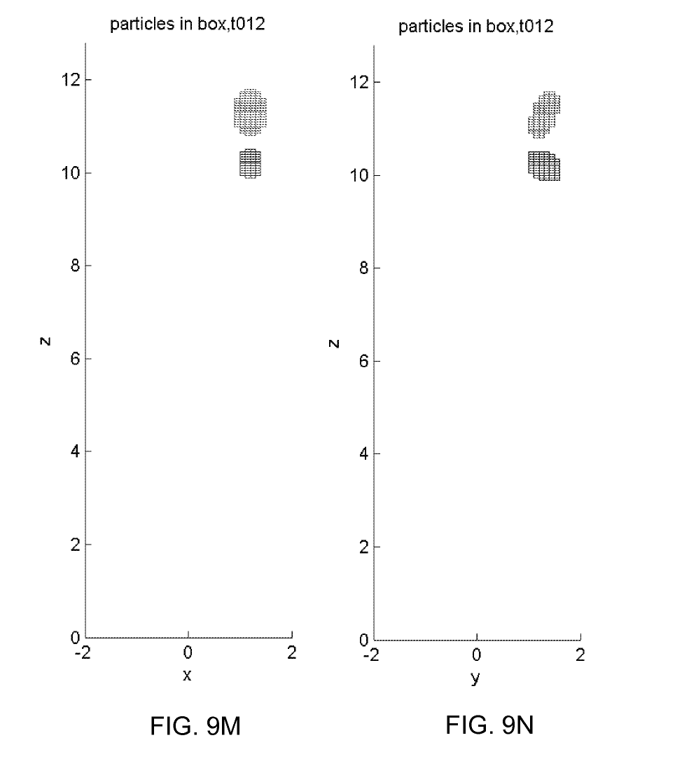

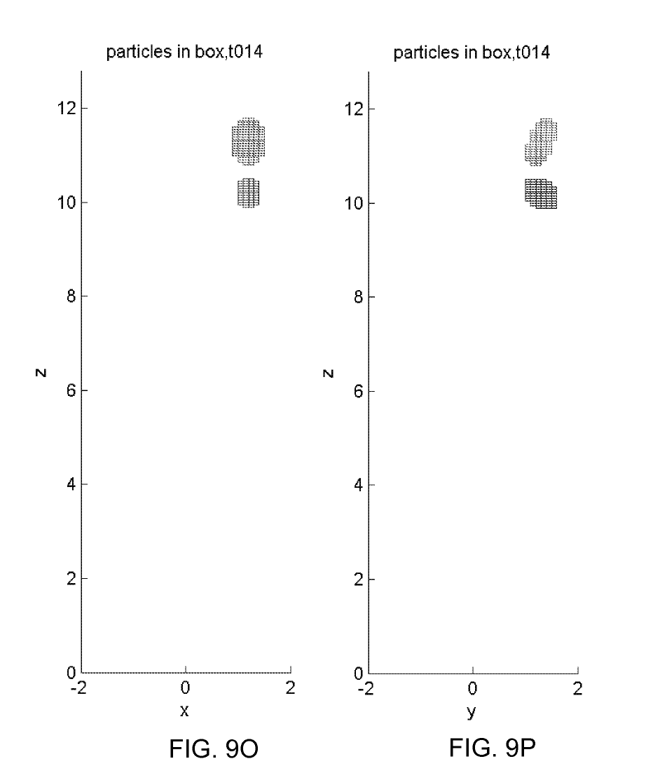

Here the above-described collision theory and algorithm is used to simulate the movement of two ellipsoid particles as shown in FIGS. 9A-9P. Two views of two particles are shown at each of eight (8) different times. Each of FIGS. 9A, 9C, 9E, 9G, 91, 9K, 9M and 9O is a front view of the particles, each at one of the different times. Each of FIGS. 9B, 9D, 9F, 9H, 9J, 9L, 9N and 9P is a side view of the particles, each at one of the different times.

The upper particle (particle A) of major axes (a, b, c)=(0.5, 0.3, 0.2) is initially located at (1.2, 1.3, 11.3) with initial orientation (0.5, 1.01, 3.77). The lower particle (particle B) of major axes (a, b, c)=(0.35, 0.25, 0.2) is initially located at (1.2, 1.3, 10.2) with initial orientation (1.37, −1.65, −2.20). The linear and angular velocities of particle A are (−0.03, −0.05, −9.20) and (0.1, −0.4, 0.6), respectively. The linear and angular velocities of particle B are (−0.05, −0.02, −0.10) and (0.7, −0.4, −0.3), respectively. Since particle A falls much faster than particle B, it hits particle B. Here, the collision is considered fully elastic and frictionless, which is to say the restitution coefficient is 1.0 and the friction coefficient is 0. By using the disclosed collision theory, the linear and angular velocities of both particles can be determined. After the collision, these two particles separate from each other. Particle A falls down slower and particle B falls quicker because of the collision effect. They will continue falling down until both of them hit the bottom of the box. The result shows that the collision theory and algorithm work well.

As the foregoing demonstrates, the present disclosure provides a method to determine whether two or more ellipsoidal particles collide. The disclosure also sets forth an algorithm to determine the location of the collision point between two ellipsoids, if such a collision occurs. A collision theory is provided that predicts the new (after collision) linear and angular velocities of the colliding particles. Moreover, by adjusting the restitution and friction coefficients, the collision theory can accommodate elastic and non-elastic collisions.

### III. Systems for Implementation

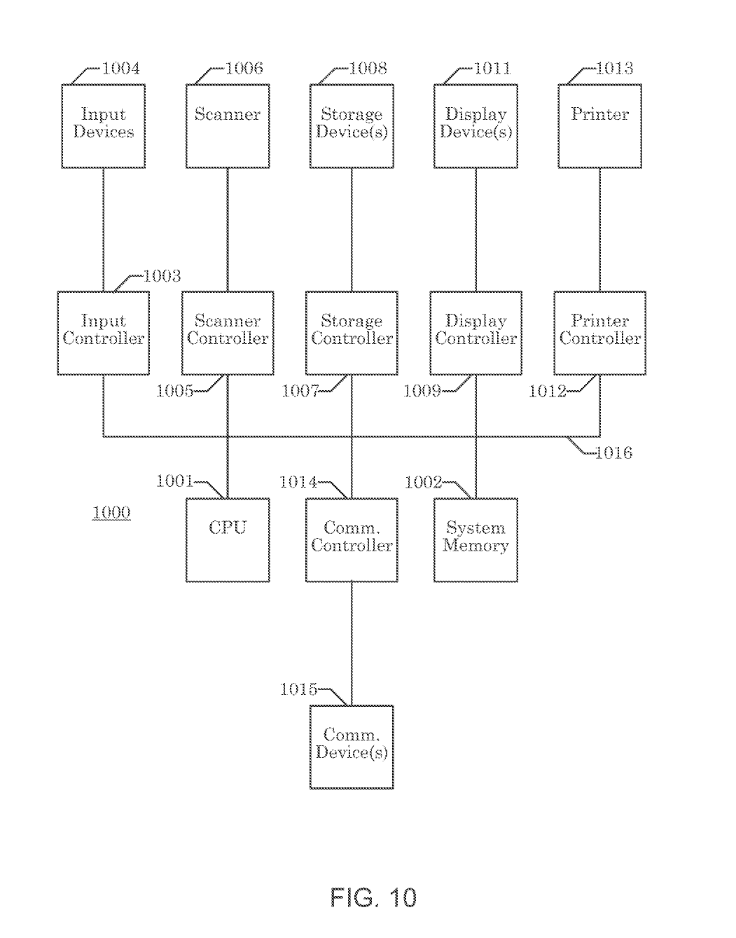

Having described the details of various embodiments and aspects of the invention, an exemplary system 1000, which may be used to implement one or more such embodiments or aspects, will now be described with reference to FIG. 10. As illustrated in FIG. 10, the system includes a central processing unit (CPU) 1001 that provides computing resources and controls the system. CPU 1001 may be implemented with a microprocessor or the like, and may also include a graphics processor and/or a floating point coprocessor for mathematical computations. System 1000 may also include system memory 1002, which may be in the form of random-access memory (RAM) and read-only memory (ROM).

A number of controllers and peripheral devices may also be provided, as shown in FIG. 10. An input controller 1003 represents an interface to various input device(s) 1004, such as a keyboard, mouse, or stylus. There may also be a scanner controller 1005, which communicates with a scanner 1006. System 1000 may also include a storage controller 1007 for interfacing with one or more storage devices 1008 each of which includes a storage medium such as magnetic tape or disk, or an optical medium that might be used to record programs of instructions for operating systems, utilities and applications which may include embodiments of programs that implement various aspects of the present invention. Storage device(s) 1008 may also be used to store processed data or data to be processed in accordance with the invention. System 1000 may also include a display controller 1009 for providing an interface to a display device 1011, which may be any known type of display. System 1000 may also include a printer controller 1012 for communicating with a printer 1013. A communications controller 1014 may interface with one or more communication devices 1015, which enables system 1000 to connect to remote devices through any of a variety of networks including the Internet, a local area network (LAN), a wide area network (WAN), or through any suitable wireless protocol.

In the illustrated system, all major system components may connect to a bus 1016, which may represent more than one physical bus. However, various system components may or may not be in physical proximity to one another. For example, input data and/or output data may be remotely transmitted from one physical location to another. In addition, programs that implement various aspects of this invention may be accessed from a remote location (e.g., a server) over a network. Such data and/or programs may be conveyed through any of a variety of machine-readable or tangible medium including magnetic tape or disk or optical disc, or a transmitter-receiver pair.

The present invention may be conveniently implemented with software. However, alternative implementations are certainly possible, including a hardware implementation or a software/hardware implementation. Any hardware-implemented functions may be realized using ASIC(s), digital signal processing circuitry, or the like. Accordingly, the term “tangible medium” as used herein includes any such medium having instructions implemented in software or hardware, or a combination thereof, embodied thereon. With these implementation alternatives in mind, it is to be understood that the figures and accompanying description provide the functional information one skilled in the art would require to write program code (i.e., software) or to fabricate circuits (i.e., hardware) to perform the processing required.

In accordance with further aspects of the invention, any of the above-described methods or steps thereof may be embodied in a program of instructions (e.g., software), which may be stored on, or conveyed to, a computer or other processor-controlled device for execution on a computer-readable medium. Alternatively, any of the methods or steps thereof may be implemented using functionally equivalent hardware (e.g., application specific integrated circuit (ASIC), digital signal processing circuitry, etc.) or a combination of software and hardware.

While the invention has been described in conjunction with several specific embodiments, further alternatives, modifications, and variations will be apparent to those skilled in the art in light of the foregoing description. Thus, the invention described herein is intended to embrace all such alternatives, modifications, and variations as may fall within the spirit and scope of the appended claims.

What is claimed is:

1. A non-transitory medium encoded with instructions for execution by one or more processors to determine particle information in a particulate fluid flow in a simulation space, the instructions comprising:
instructions for setting a rigidity constraint force on particles in the particulate flow to an initial value;
instructions for evaluating a plurality of governing equations including momentum equations together with an incompressibility constraint;
instructions for obtaining a velocity field in a particle domain by projecting a flow field of the particles onto a rigid body motion space;
instructions for calculating a new value for the rigidity constraint force;
instructions for calculating a force and torque on the particles from the fluid; and
instructions for determining, based at least in part on the calculated force and torque on the particles, updated velocity components, position, and orientation of at least one of the particles.

2. The non-transitory medium as recited in claim 1, wherein the initial value is zero.

3. The non-transitory medium as recited in claim 1, wherein the instructions for calculating a force and torque on the particles includes instructions for calculating stress on the surfaces of the particles and evaluating surface integrals on the particles to obtain the force and torque.

4. The non-transitory medium as recited in claim 1, wherein the instructions for determining updated velocity components, position, and orientation of at least one of the particles is also based on other body forces.

5. The non-transitory medium as recited in claim 1, further comprising:
instructions for adding collision forces and updating the linear and angular velocity components of each particle determined to have collided, if any collisions have occurred.

6. A non-transitory medium encoded with instructions for execution by one or more processors to execute to determine collision information with respect to particles in a particulate fluid flow simulation carried out in a computational domain divided into a plurality of mesh cells, the instructions comprising:
instructions for determining a force of each collision among the particles; and
instructions for carrying out calculations for determining velocity components, position, and orientation of at least one of the two colliding particles after or during collision, wherein, the calculations are performed taking the center of the mesh cell in which the collision occurs as the contact point.
